(19) United States
(12) Patent Application Publication
(10) Pub. No.: US 2011/0306390 A1
(43) Pub. Date: Dec. 15, 2011

(54) APPARATUS AND METHOD FOR READING DATA

(75) Inventor: Myeong-Seon SEO, Seoul (KR)

(73) Assignee: PANTECH CO., LTD., Seoul (KR)

(21) Appl. No.: 12/813,177

(22) Filed: Jun. 10, 2010

(51) Int. Cl. H04W 8/00; G06F 12/00

(52) U.S. Cl. 455/558; 711/154; 711/E12.001

(57) ABSTRACT

An apparatus to read data includes a command receiving unit to receive a read record command with respect to data stored in the apparatus, a record identification unit to identify a valid record from among records corresponding to the stored data based on the received read record command, and a data read unit to read data corresponding to the valid record. A method for reading data includes receiving a read record command with respect to data stored in an apparatus, receiving a read record command with respect to stored data, identifying a valid record from among records corresponding to the stored data based on the received read record command, and reading data corresponding to the identified valid record.

### BACKGROUND

1. Field of the Disclosure

Exemplary embodiments of the present invention relate to an apparatus and method for reading data stored in the apparatus.

2. Discussion of the Background

A subscriber identity module (SIM), a universal subscriber identity module (USIM), and the like may be given as a representative example of a smart card module used in a mobile terminal.

In general, the SIM may be detachably applied to a mobile terminal capable of operating according to a global system for mobile communications (GSM) scheme. In the SIM, information concerning a subscriber of the mobile terminal and information concerning a mobile terminal system may be stored. Accordingly, the mobile terminal to which the SIM is applied is may use the information stored in the SIM as is, regardless of a type of the mobile terminal.

For example, a call history of the subscriber, subscriber designation information of the mobile terminal, system information, and the like may be stored in the SIM. In this case, the subscriber may detach the SIM from a first mobile terminal, apply the SIM to a second mobile terminal, and then use the information stored in the SIM in the second mobile terminal.

In this manner, the SIM may provide convenience to the subscriber when using the mobile terminal. Thus, the SIM has been recently applied even to a mobile terminal of a Code Division Multiple Access (CDMA) scheme.

However, to read a record-type file from the SIM, the mobile terminal may transmit a read record command for all records, receive data in response to the read record command, and read the received data. In each record, null data as well as valid data may exist. However, the mobile terminal may need to read all the records because information about data does not exist in each record.

As a representative example of the record-typed file, files associated with a phonebook, that is, Abbreviated Dialing Numbers (ADN) may be given. However, ADNs are generally limited to 250 and 500 records. In addition, data associated with the phonebook may increase with the increase in a memory capacity of the SIM.

### SUMMARY

Exemplary embodiments of the present invention provide an apparatus and method for reading data that may improve a speed of reading data from a Subscriber Identity Module (SIM) and may selectively retrieve a valid record from the SIM.

Exemplary embodiments of the present invention also provide an apparatus and is method for reading data that may reduce a time used for reading data from an SIM.

Exemplary embodiments of the present invention further provide an apparatus and method for reading data that may reduce a boot time for a mobile terminal to which an SIM is applied.

Exemplary embodiments of the present invention still further provide an apparatus and method for reading data that may be operated in an interface between a mobile terminal and an existing SIM, and may ensure compatibility between the mobile terminal and the existing SIM.

Additional features of the invention will be set forth in the description which follows, and in part will be apparent from the description, or may be learned by practice of the invention.

An exemplary embodiment of the present invention discloses an apparatus to read data, the apparatus including: a command receiving unit to receive a read record command with respect to data stored in the apparatus; a record identification unit to identify a first valid record from among records corresponding to the stored data based on the received read record command; and a data read unit to read data corresponding to the first valid record.

An exemplary embodiment of the present invention discloses an apparatus to read data, including: a mode definition unit to define a selective mode, the selective mode being a mode of selectively reading a valid record from among records corresponding to data stored in a SIM; a command transmission unit to transmit a read record command to the SIM by applying the defined selective mode to the read record command; and a data receiving unit to receive, in response to the read record command, data corresponding to the valid record from the SIM.

An exemplary embodiment of the present invention discloses a method for is reading data, the method including: receiving a read record command with respect to data stored in an apparatus; identifying a first valid record from among records corresponding to the stored data based on the received read record command; and reading data corresponding to the first valid record.

An exemplary embodiment of the present invention discloses a method for reading data, including: defining a selective mode, the selective mode being a mode of selectively reading a valid record from among records corresponding to data stored in a SIM; transmitting a read record command to the SIM by applying the defined selective mode to the read record command; and receiving, in response to the read record command, data corresponding to the valid record from the SIM.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a directory structure of files stored in a Subscriber Identity Module (SIM) in a related art.

FIG. 2 is a diagram illustrating a structure of a record stored in an Element File (EF) of FIG. 1.

FIG. 3 is a block diagram illustrating a SIM to which an exemplary apparatus to read data is applied, and a mobile terminal to which an exemplary apparatus to read data is applied.

FIG. 4 is a block diagram illustrating the SIM of FIG. 3.

FIG. 5 is a block diagram illustrating the mobile terminal of FIG. 3.

FIG. 6 is a diagram illustrating an example of a format of a read record command used in an exemplary embodiment of the present invention.

FIG. 7 is a diagram illustrating an example of values designated in a second parameter region of FIG. 6.

FIG. 8 is a diagram illustrating an example of reading data from an SIM supporting a selective mode according to an exemplary embodiment of the present invention.

FIG. 9 is a diagram illustrating an example of reading data from an SIM that does not support a selective mode according to an exemplary embodiment of the present invention.

FIG. 10 is a flowchart illustrating a method for reading data according to an exemplary embodiment of the present invention.

FIG. 11 is a flowchart illustrating a method for reading data according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to is the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

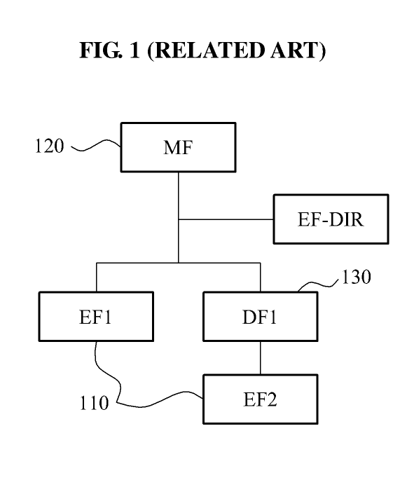

FIG. 1 is a diagram illustrating a directory structure of files stored in a Subscriber Identity Module (SIM) in a related art.

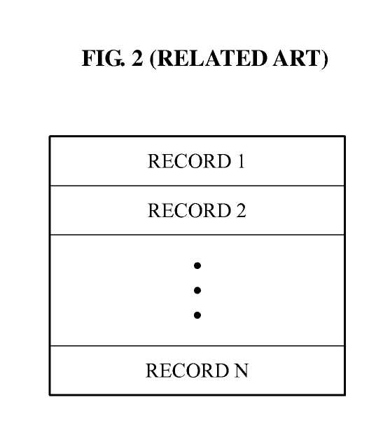

As illustrated in FIG. 1, an Elementary File (EF) 110 may designate a file of a lowest level concept, and may exist in a lower level of a Master File (MF) 120 or a Dedicated File (DF) 130. Stored data such as data concerning a subscriber may be generally stored in the EF 110. The EF 110 may be categorized into a transparent type, a linear fixed type, and a cyclic type. Of these, the EFs 110 of the linear fixed type and of the cyclic type may have a structure in which several pieces of data of a record type exist, as illustrated in FIG. 2. FIG. 2 is a diagram illustrating a structure of a record stored in the EF 110 of FIG. 1.

Exemplary embodiments related to an apparatus and method for reading data stored in a directory and a record, such as the directory and record illustrated in FIG. 1 and FIG. 2, will now be described with reference to the drawings.

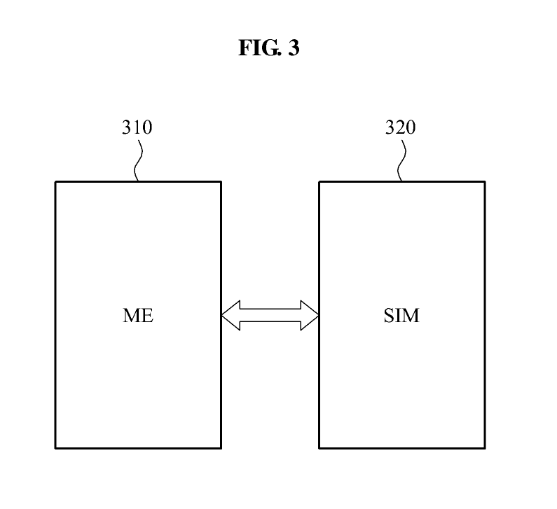

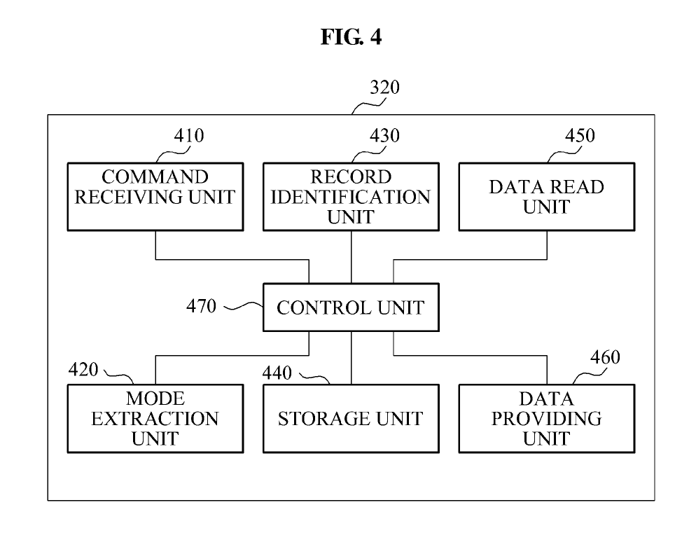

FIG. 3 is a block diagram illustrating an SIM to which an exemplary apparatus of reading data is applied, and a mobile terminal to which an exemplary apparatus of reading data is applied. FIG. 4 is a block diagram illustrating the SIM of FIG. 3.

Referring to FIG. 3 and FIG. 4, a SIM 320 includes a command receiving unit 410, a mode extraction unit 420, a record identification unit 430, a storage unit 440, a data read unit 450, a data providing unit 460, and a control unit 470.

The command receiving unit 410 may receive, from a mobile terminal (ME) 310, is a read record command with respect to the data stored in the SIM 320. In this instance, the command receiving unit 410 may receive, from the mobile terminal 310, the read record command through an interface between the mobile terminal 310 and the SIM 320.

The mode extraction unit 420 may extract a selective mode (selective mode-related information) from the received read record command. In this instance, the mode extraction unit 420 may extract the selective mode from a parameter region within the received read record command. Here, the selective mode may be a mode of selectively reading a valid record from among records corresponding to the stored data, and may be defined by the mobile terminal 310.

The record identification unit 430 may identify a first valid record from among the records corresponding to the stored data based on the received read record command. That is, the record identification unit 430 may selectively identify a first valid record from among the records corresponding to the stored data using the extracted selective mode.

In this instance, the record identification unit 430 may identify, as the first valid record, a record corresponding to data having a valid data range from among data corresponding to each of the records corresponding to the stored data. Otherwise, the record identification unit 430 may identify, as the first valid record, a record having a value different from a predetermined value, such as 0xFF, from among record values corresponding to each of the records corresponding to the stored data.

The storage unit 440 may store a record number corresponding to the identified valid record. In this instance, the storage unit 440 may store all record numbers at a time, when a plurality of records numbers exists. Also, the storage unit 440 may store a corresponding single record number every time data corresponding to the record number is read.

The data read unit 450 may read data corresponding to the identified valid record. Here, when a plurality of the identified valid records exists, the data read unit 450 may read data corresponding to each valid record based on the stored record number. That is, the data read unit 450 may read the data corresponding to each valid record in a sequential manner depending on a magnitude of the stored record number. In this instance, the data read unit 450 may read a single piece of data corresponding to each valid record every time the read record command is received.

The data providing unit 460 may provide data corresponding to the identified valid record to the mobile terminal 310. In this instance, the data providing unit 460 may provide the data to the mobile terminal 310 through an interface between the mobile terminal 310 and the SIM 320.

The control unit 470 may control the SIM 320, that is, the control unit 470 may control operations of the command receiving unit 410, the mode extraction unit 420, the record identification unit 430, the storage unit 440, the data read unit 450, and the data providing unit 460.

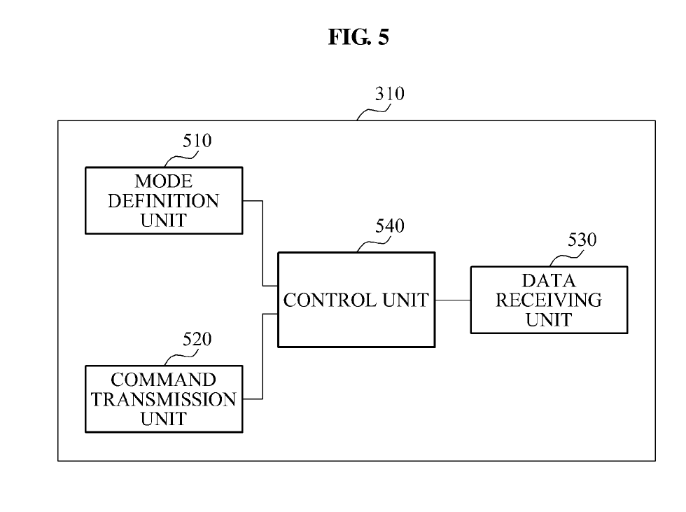

FIG. 5 is a block diagram illustrating the mobile terminal of FIG. 3

Referring to FIG. 3 and FIG. 5, the mobile terminal 310 includes a mode definition unit 510, a command transmission unit 520, a data receiving unit 530, and a control unit 540.

The mode definition unit 510 may define a selective mode. Here, the selective mode may designate a mode of selectively reading a valid record from among records corresponding to stored data stored in the SIM 320, as described above.

The command transmission unit 520 may apply the defined selective mode to a read record command and transmit the read record command to the SIM 320. In this instance, is the command transmission unit 520 may apply the defined selective mode to a parameter region within the read record command and transmit the read record command to the SIM 320.

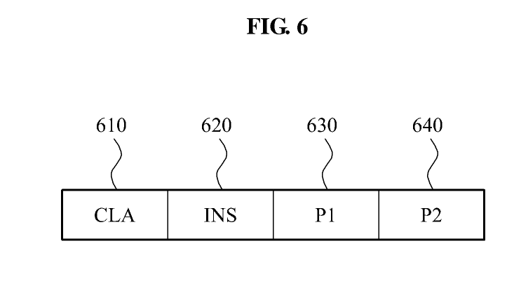

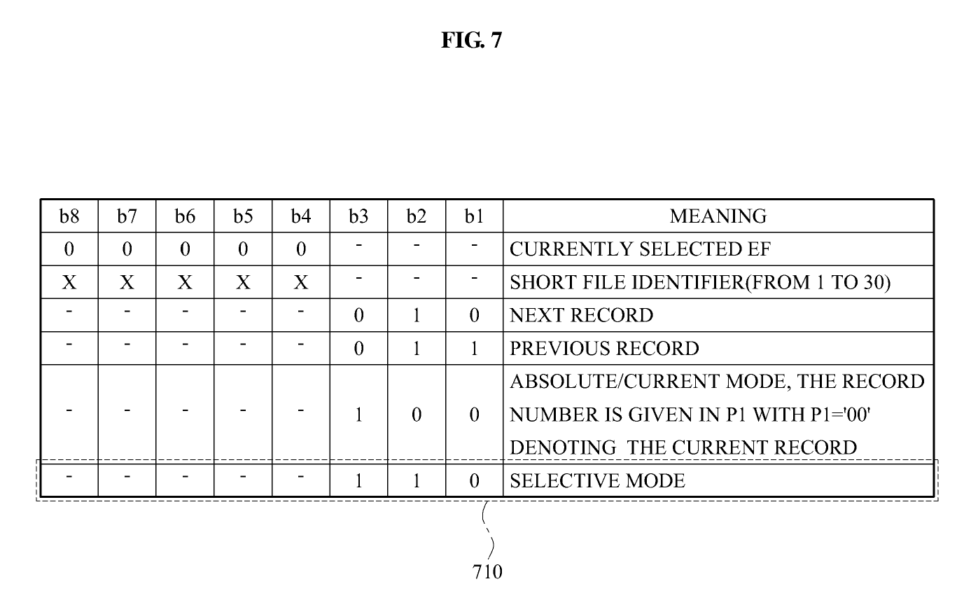

This will be described in more detail with reference to FIG. 6 and FIG. 7. FIG. 6 is a diagram illustrating an example of a format of a read record command used in an exemplary embodiment of the present invention, and FIG. 7 is a diagram illustrating an example of values designated in a second parameter region of FIG. 6.

As illustrated in FIG. 6 and FIG. 7, in a second parameter region 640 of the read record command, values illustrated in FIG. 7 may be designated. Particularly, in a section 710 of FIG. 7, information concerning the selective mode, that is, selective mode designation values may be shown.

The command transmission unit 520 of FIG. 5 may apply the selective mode to the second parameter region 640 as in the section 710 of FIG. 7, and transmit, to the SIM 320 of FIG. 3, the read record command including the second parameter region 640 and other regions, that is, a class region 610, a command region 620, and a first parameter region 630.

Referring again to FIG. 3 and FIG. 5, the data receiving unit 530 may receive, in response to the read record command, data corresponding to the valid record from the SIM 320. Accordingly, the data receiving unit 530 may transmit the received data to the mobile terminal 310, and thereby the received data may be displayed or operated in the mobile terminal 310.

The control unit 540 may control the mobile terminal 310, that is, control operations of the mode definition unit 510, the command transmission unit 520, and the data receiving unit 530.

In addition, the mobile terminal 310 may further include a mode determination unit (not illustrated).

The mode determination unit may determine whether the SIM 320 supports the selective mode. For this purpose, the mode determination unit may analyze a response to the read record command. When the response includes an error message based on the analyzed result, the mode determination unit may determine that the SIM 320 does not support the selective mode. Conversely, when the response does not include the error message based on the analyzed result, the mode determination unit may determine that the SIM 320 supports the selective mode.

When the SIM 320 supports the selective mode based on the determined result, the data receiving unit 530 may receive data corresponding to the valid record excluding a null record from among the records corresponding to the stored data.

However, when the SIM 320 does not support the selective mode based on the determined result, the command transmission unit 520 may transmit, to the SIM 320, the read record command using one of a previous mode, a next mode, and an absolute mode, which are different from the selective mode. Accordingly, the data receiving unit 530 may receive all of data corresponding to each record, whether valid or null, corresponding to the stored data. In this instance, the data receiving unit 530 may receive a single piece of response (including data) to the read record command every time the read record command is transmitted.

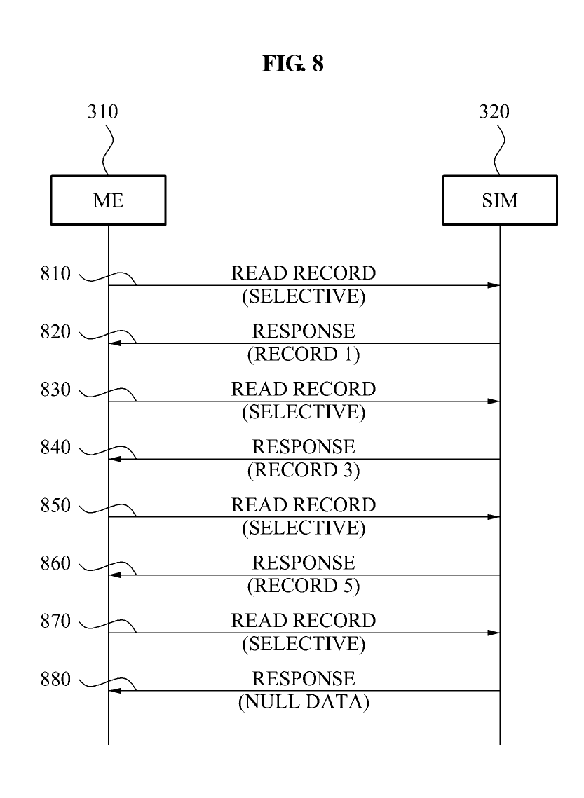

FIG. 8 is a diagram illustrating an example of reading data from a SIM supporting a selective mode according to an exemplary embodiment of the present invention. Here, a file corresponding to the data may be a linear fixed type, and have ten records. For this example, it is assumed that a record 1, a record 3, and a record 5 of the ten records are valid records.

As illustrated in FIG. 8, the mobile terminal 310 may transmit, to the SIM 320, a read record command 810 using a selective mode. Next, the SIM 320 may identify a first valid is record from among the ten records, and transmit, to the mobile terminal 310, a response 820 including data and a record number corresponding to the valid record 1 having the lowest record number.

In this instance, the SIM 320 may store a finally transmitted record number (the record 1). Accordingly, the SIM 320 may determine a record number transmitted after the record 1.

Subsequently, the mobile terminal 310 may transmit, to the SIM 320, a read record command 830 using the selective mode. Next, the SIM 320 may transmit, to the mobile terminal 310, a response 840 including data and a record number of the next valid record 3, that is, the lowest record number from among record numbers having numbers greater than that of a previously transmitted record number from among the identified valid records.

Subsequently, the mobile terminal 310 may transmit, to the SIM 320, a read record command 850 in the same manner as described above, and the SIM 320 may transmit, to the mobile terminal 310, a response 860 to the transmitted read record command 850. The response 860 may include data and a record number of the next valid record 5.

Finally, in a case where the mobile terminal 310 transmits a read record command 870 to the SIM 320, the SIM 320 may transmit, to the mobile terminal 310, a response 880 including null data and a status word when there are no further valid records. Accordingly, the mobile terminal 310 may determine that the valid data concerning a corresponding file no longer exists in the SIM 320 using the transmitted response 880, and may terminate to read the corresponding file.

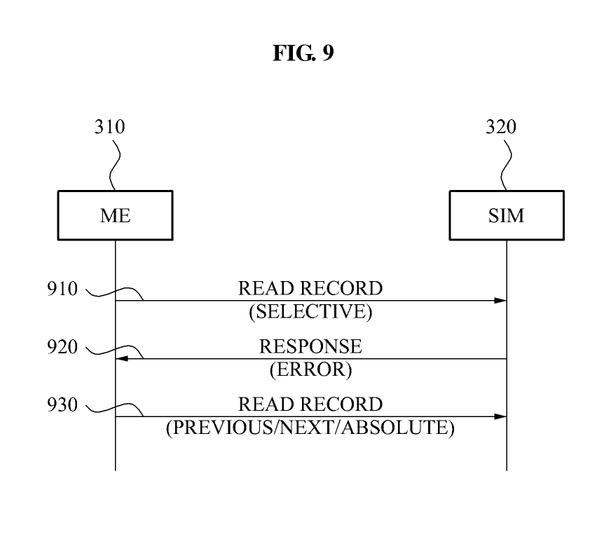

FIG. 9 is a diagram illustrating an example of reading data from a SIM that does not support a selective mode according to an exemplary embodiment of the present invention.

As illustrated in FIG. 9, the mobile terminal 310 may transmit, to the SIM 320, a read record command 910 using the selective mode. In this instance, when the SIM 320 transmits, to the mobile terminal 310, an error message as a response 920, the mobile terminal 310 may determine the SIM 320 does not support the selective mode.

Accordingly, the mobile terminal 310 may transmit, to the SIM 320, a read record command 930 using one of a previous mode, a next mode, and an absolute mode, which are different from the selective mode. Accordingly, the mobile terminal 310 and the SIM 320 may mutually transmit and receive a single read record command and the response (valid/null data) to the read record command.

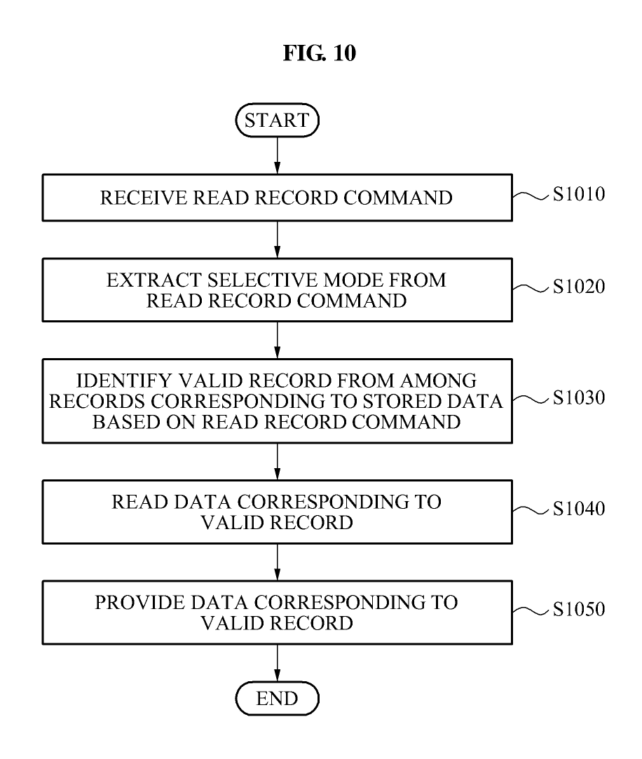

FIG. 10 is a flowchart illustrating a method for reading data according to an exemplary embodiment of the present invention. Here, the method may be performed by SIM 320 of FIG. 4, and will be described as such only for ease of description, and not to limit the scope of this disclosure.

Referring to FIG. 3 and FIG. 10, in operation S1010, the SIM 320 may receive, from the mobile terminal 310, a read record command with respect to the stored data. In this instance, the SIM 320 may receive, from the mobile terminal 310, the read record command through an interface between the mobile terminal 310 and the SIM 320.

In operation S1020, the SIM 320 may extract, from the received read record command, information concerning a selective mode. In this instance, the SIM 320 may extract, from a parameter region within the received read record command, the information concerning the selective mode.

In operation S1030, the SIM 320 may identify a valid record from among records corresponding to the stored data based on the received read record command. That is, the SIM 320 may selectively identify the valid record from among the records corresponding to the stored data using information concerning the extracted selective mode.

In this instance, the SIM 320 may identify, as the valid record, a record corresponding to data having a valid data range from among data corresponding to each of the records corresponding to the stored data. Otherwise, the apparatus may identify, as the valid record, a record having a value that is different from that of 0xFF from among record values corresponding to each of the records corresponding to the stored data.

In operation S1040, the SIM 320 may read data corresponding to the identified valid record. In this instance, the SIM 320 may store a record number corresponding to the identified valid record.

Here, when a plurality of the identified valid records exists, the SIM 320 may read data corresponding to each valid record. That is, the SIM 320 may read the data corresponding to each valid record in a sequential manner depending on a magnitude of the stored record number. In this instance, the SIM 320 may read a single piece of the data corresponding to the plurality of valid records every time the read record command is received.

In operation S1050, the SIM 320 may provide data corresponding to the identified valid record to the mobile terminal 310. In this instance, the SIM 320 may provide the data to the mobile terminal 310 through an interface between the mobile terminal 310 and the SIM 320.

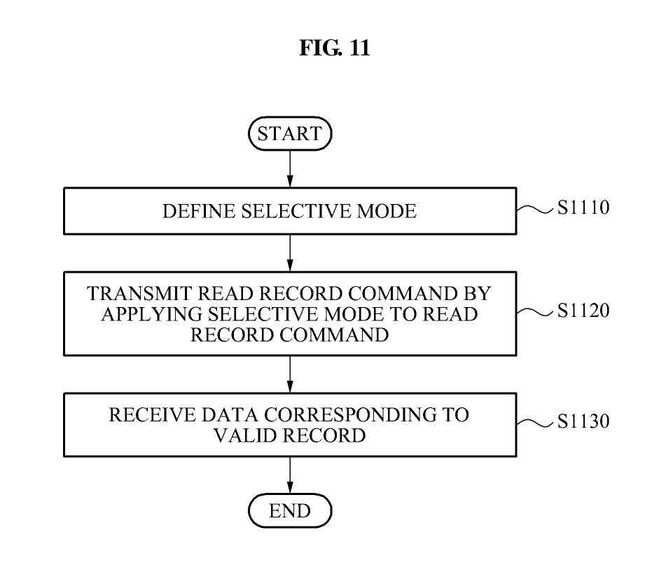

FIG. 11 is a flowchart illustrating a method for reading data according to an exemplary embodiment of the present invention. Here, the method may be performed by the mobile terminal 310 of FIG. 5, and will be described as such only for ease of description, and not to limit the scope of this disclosure.

Referring to FIG. 3 and FIG. 11, in operation S1110, the mobile terminal 310 may is define a selective mode. Here, the selective mode may designate a mode of selectively reading a valid record from among records corresponding to stored data stored in the SIM 320, as described above.

In operation S1120, the mobile terminal 310 may apply the defined selective mode to a read record command to transmit the read record command to the SIM 320. In this instance, the mobile terminal 310 may apply the defined selective mode to a parameter region within the read record command to transmit the read record command to the SIM 320. That is, the mobile terminal 310 may insert information concerning the defined selective mode into the parameter region within the read record command, and then transmit the read record command to the SIM 320.

In operation S1130, the mobile terminal 310 may receive, in response to the read record command, data corresponding to the valid record from the SIM 320. Accordingly, the SIM 320 may transmit the received data to the mobile terminal 310, and thereby the received data may be displayed or operated in the mobile terminal 310.

Exemplary embodiments of the present invention may be applied to the interface between the mobile terminal 310 and the SIM 320.

The method for reading data according to the above-described exemplary embodiments of the present invention may be recorded in computer-readable media including program commands to implement various operations embodied by a computer. The media may also include, alone or in combination with the program commands, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program commands, such as read-only memory (ROM), random access memory (RAM), flash memory, and the like. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to read data, comprising:
a command receiving unit to receive a read record command with respect to data stored in the apparatus;
a record identification unit to identify a first valid record from among records corresponding to the stored data based on the received read record command; and
a data read unit to read data corresponding to the first valid record.

2. The apparatus of claim 1, further comprising:
a mode extraction unit to extract a selective mode from the read record command, the selective mode being a mode of selectively reading the first valid record from among the records,
wherein the record identification unit identifies the first valid record from among the records using the extracted selective mode.

3. The apparatus of claim 1, further comprising:
a storage unit to store a record number corresponding to the first valid record,
wherein if a plurality of valid records exists, the data read unit reads data corresponding to each valid record based on a stored record number of each valid record.

4. The apparatus of claim 3, wherein the data read unit reads a single valid record every time the read record command is received.

5. The apparatus of claim 1, wherein the record identification unit identifies, as the first valid record, a record corresponding to data within a valid data range from among data corresponding to each of the records.

6. The apparatus of claim 1, wherein the record identification unit identifies, as the first valid record, a record having a value different from that of 0xFF from among record values corresponding to each record.

7. The apparatus of claim 1, further comprising:
a data providing unit to provide data corresponding to the first valid record to a mobile terminal.

8. An apparatus to read data, comprising:
a mode definition unit to define a selective mode, the selective mode being a mode of selectively reading a valid record from among records corresponding to data stored in a subscriber identity module (SIM);
a command transmission unit to transmit a read record command to the SIM by applying the defined selective mode to the read record command; and
a data receiving unit to receive, in response to the read record command, data corresponding to the valid record from the SIM.

9. The apparatus of claim 8, wherein the command transmission unit applies the defined selective mode to a parameter region of the read record command.

10. A method for reading data, comprising:
receiving a read record command with respect to data stored in an apparatus;
identifying a first valid record from among records corresponding to the stored data based on the received read record command; and
reading data corresponding to the first valid record.

11. The method of clam 10, further comprising:
extracting a selective mode from the read record command, the selective mode being a mode of selectively reading a valid record from among the records, and being defined by a mobile terminal,
wherein the step of identifying comprises identifying the first valid record from among the records using the extracted selective mode.

12. The method of claim 10, further comprising:
storing a record number corresponding to the first valid record,
wherein if a plurality of valid records exists, the step of reading comprises reading data corresponding to each valid record based on a stored record number of each valid record.

13. A method for reading data, comprising:
defining a selective mode, the selective mode being a mode of selectively reading a valid record from among records corresponding to data stored in a subscriber identity module (SIM);
transmitting a read record command to the SIM by applying the defined selective mode to the read record command; and
receiving, in response to the read record command, data corresponding to the valid record from the SIM.

14. The apparatus of claim 1, wherein the record identification unit identifies the first valid record from among records corresponding to the stored data based on a first read record command, and identifies a second valid record from among records corresponding to the stored data based on a second read record command.

15. The method of clam 10, further comprising:
identifying a second valid record from among records corresponding to the stored data based on a subsequently received read record command.
